(19) United States
(12) Patent Application Publication
(10) Pub. No.: US 2011/0282514 A1
(43) Pub. Date: Nov. 17, 2011

(54) SYSTEMS AND METHODS FOR FORECASTING SOLAR POWER

(76) Inventors: Michael Ropp, Brookings, SD (US); Steven G. Hummel, Bend, OR (US)

(21) Appl. No.: 13/103,629

(22) Filed: May 9, 2011

Related U.S. Application Data
(60) Provisional application No. 61/332,683, filed on May 7, 2010.
(60) Provisional application No. 61/369,255, filed on Jul. 30, 2010.

(51) Int. Cl. G06F 1/28; G06F 19/00; G01W 1/00

(52) U.S. Cl. 700/297; 702/3

(57) ABSTRACT

A solar power forecasting system can provide forecasts of solar power output by photovoltaic plants over multiple time frames. A first time frame may be several hours from the time of the forecast, which can allow utility personnel sufficient time to make decisions to counteract a forecasted shortfall in solar power output. For example, the utility personnel can decide to increase power production and/or to purchase additional power to make up for any forecasted shortfall in solar power output. A second time frame can be several minutes from the time of the forecast, which can allow for operations to mitigate effects of a forecasted shortfall in solar power output. Such mitigation operations can include directing an energy management system to shed noncritical loads and/or ramping down the power produced by the photovoltaic plants at a rate that is acceptable to the utility to which the photovoltaic plants provide power.

### CROSS REFERENCE TO RELATED APPLICATION

This application claims the benefit of U.S. Provisional Patent Application Nos. 61/332,683 filed May 7, 2010, and 61/369,255 filed Jul. 30, 2010, both of which are incorporated herein by reference in their entireties.

### TECHNICAL FIELD

This application describes systems and methods for forecasting solar power output of photovoltaic plants.

### BACKGROUND

A photovoltaic plant includes one or more arrays of photovoltaic modules that convert solar energy into direct current and one or more solar power inverters that convert the direct current into alternating current (alternatively referred to as electrical power or power) usable by a utility or a load. The photovoltaic plant can also include various other components, such as wiring structures between the photovoltaic modules and the solar power inverters (e.g., string combiners). The passage of clouds over the photovoltaic arrays may induce transients in power produced by the photovoltaic plant. For example, a cloud (e.g., a dark cumulus cloud) passing over the photovoltaic arrays can block out direct irradiance, which can account for up to approximately 80% of the total irradiance at the photovoltaic arrays. Such decrease in direct irradiance can cause a correspondingly large dip in the power produced by the photovoltaic plant.

To a utility, a photovoltaic plant appears as a negative load. From the utility's perspective, the large dip in the photovoltaic plant power output caused by a cloud shadow appears to be a sudden increase in the load. At the local level, the transient induced by a cloud could cause a voltage sag, leading to unacceptable voltage deviations, excessive operation of voltage regulation devices, and/or load malfunction. Customer costs could also be impacted; a customer facility with a fast-ramping photovoltaic system could incur greater demand charges during cloud transients.

If there is a non-trivial amount of power produced by photovoltaic plants at the control area level, there could be frequency perturbations, or expensive area control error (ACE) penalties if the utility is suddenly forced to violate normal import/export limits. Utilities can mitigate such transient effects by operating more spinning reserves or by activating load shedding. However, both mitigation actions can cause the utility to incur extra costs, which can in turn cause the utility to raise electric rates.

### BRIEF DESCRIPTION OF THE DRAWINGS

FIG. 1 is a diagram illustrating a system for forecasting solar power configured in accordance with an embodiment of the technology.

FIG. 2 is a block diagram of a computing system that may employed with the system for forecasting solar power of FIG. 1.

FIG. 3 is a flow diagram of a process for forecasting solar power in accordance with an embodiment of the technology.

FIG. 4 is a flow diagram of a process for forecasting solar power and performing an operation to mitigate the effects of reduced irradiance due to the passage of clouds over a photovoltaic plant in accordance with an embodiment of the technology.

FIG. 5 is a flow diagram of a process for diagnosing potential problems with a photovoltaic plant in accordance with an embodiment of the technology.

FIG. 6 is a block diagram illustrating components of a solar power inverter configured in accordance with an embodiment of the technology.

FIG. 7 is a flow diagram of a process for adjusting a maximum power point tracking algorithm based on a solar power forecast in accordance with an embodiment of the technology.

FIG. 8 is a flow diagram of a process for charging or discharging a battery based on a solar power forecast in accordance with an embodiment of the technology.

### DETAILED DESCRIPTION

### 1. Overview

The inventors have recognized that the need exists for systems and methods that overcome the above drawbacks, as well as provide additional benefits. This application describes systems and methods for forecasting solar power output of photovoltaic plants that produce electrical power from solar energy. Solar power forecasts can be made over multiple time frames. A first time frame may be several hours from the time of the forecast, such as from about two to about twelve hours from the time of the forecast. It can be important to forecast solar power output for this time frame so as to allow utility personnel sufficient time to make decisions to counteract a forecasted shortfall in solar power output. For example, the utility personnel can decide to increase power production and/or to purchase additional power to make up for any forecasted shortfall in solar power output.

A second time frame can be several minutes from the time of the forecast, such as from about one minute to about one hour from the time of the forecast. Such a forecast may not provide utility personnel enough time to increase power production and/or to purchase reserve power. However, such a forecast can still be useful, in that the forecast can allow for operations to mitigate effects of a forecasted shortfall in solar power output. Such mitigation operations can include directing an energy management system to shed noncritical loads and/or ramping down the power produced by the photovoltaic plants at a rate that is acceptable to the utility to which the photovoltaic plants provide power.

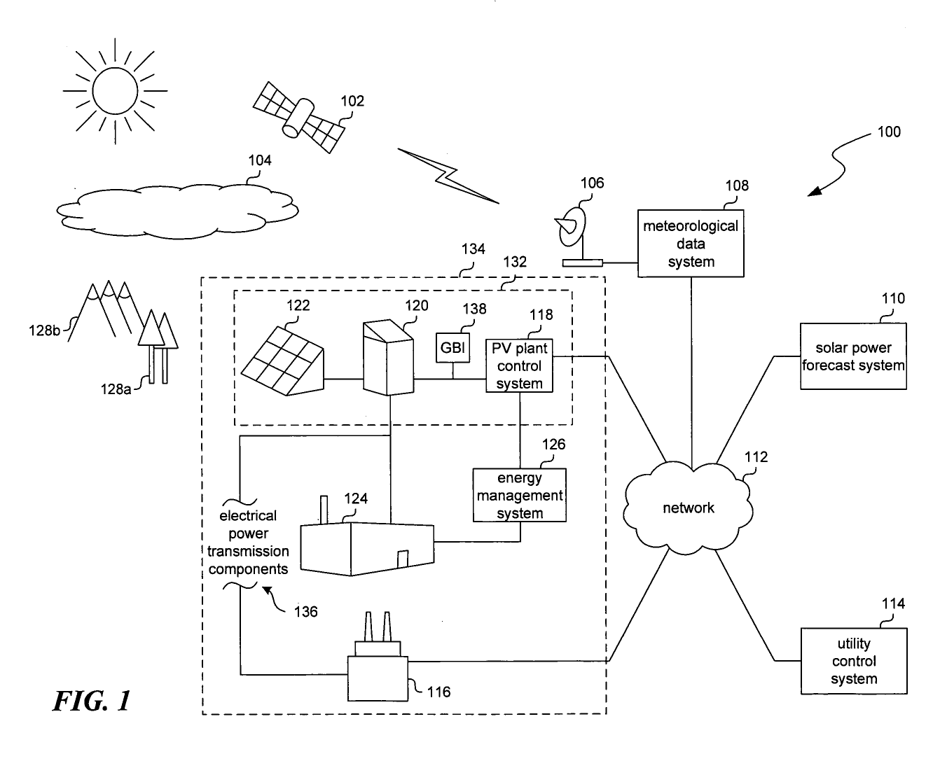

Certain details are set forth in the following description and in FIGS. 1-8 to provide a thorough understanding of various embodiments of the technology. Other details describing well-known aspects of photovoltaic plants, computing systems, solar power inverters, and other technologies referred to herein, however, are not set forth in the following disclosure so as to avoid unnecessarily obscuring the description of the various embodiments.

Many of the details, dimensions, angles and other features shown in the Figures are merely illustrative of particular embodiments. Accordingly, other embodiments can have other details, dimensions, angles and features. In addition, further embodiments can be practiced without several of the details described below.

In the Figures, identical reference numbers identify identical, or at least generally similar, elements. To facilitate the discussion of any particular element, the most significant digit or digits of any reference number refer to the Figure in which that element is first introduced. For example, element 100 is first introduced and discussed with reference to FIG. 1.

In one embodiment, a method of forecasting power output of a photovoltaic plant having a photovoltaic array includes receiving meteorological data. The meteorological data can be based upon satellite data and includes a prediction of global horizontal irradiance at the photovoltaic plant at a future time. The meteorological data can also be based upon data from other measurements, such as ground-mount assessments via irradiance meters and/or sky-view cameras. The method further includes accessing array data for the photovoltaic array. The array data can include data indicating a tilt of the photovoltaic array and an azimuth of the photovoltaic array. The method further includes calculating a predicted plane of array irradiance for the photovoltaic array at the future time based upon the predicted global horizontal irradiance and the array data, and forecasting a power output of the photovoltaic plant at the future time based on the predicted plane of array irradiance. In still a further embodiment, the method can include using post-forecast meteorological data from satellites or ground sources, such as irradiance meters and/or sky-view cameras or imagers, to assess the accuracy of the predictions or forecasts. The post-forecast meteorological data can be used to refine future forecasts based on a closed-loop feedback system that statistically correlates the post-forecast meteorological data with the forecast.

In another embodiment, a computing system for forecasting solar power output of a photovoltaic plant having a photovoltaic array includes a processor and a memory. The memory contains a predicted global horizontal irradiance for the photovoltaic plant at a future time. The predicted global horizontal irradiance data is based upon satellite data. The memory also contains tilt data indicating a tilt of the photovoltaic array and azimuth data indicating an azimuth of the photovoltaic array. The memory also contains a facility programmed to forecast solar power output of the photovoltaic plant at the future time utilizing the predicted global horizontal irradiance, the tilt data, and the azimuth data.

In another embodiment, a method of forecasting power output of a photovoltaic plant includes receiving cloud forecast data containing information about one or more clouds affecting a predetermined area that includes a photovoltaic plant having a photovoltaic array. The method further includes utilizing the cloud forecast data to predict an effect of a cloud upon plane of array irradiance at the photovoltaic array of the photovoltaic plant, and utilizing the predicted effect upon the plane of array irradiance to predict a power transient of the photovoltaic plant.

In a further embodiment, a method of controlling power produced by one or more photovoltaic modules includes receiving a prediction of future power output by a photovoltaic plant that includes one or more photovoltaic modules. The photovoltaic plant also includes a solar power inverter that generates alternating current from direct current produced by the one or more photovoltaic modules. The solar power inverter adjusts an operating voltage of the one or more photovoltaic modules according to a maximum power point tracking algorithm. The method further includes based on the prediction of future power output of the photovoltaic plant, varying the maximum power point tracking algorithm to change how the solar power inverter adjusts the operating voltage of the one or more photovoltaic modules.

### 2. Systems for Forecasting Solar Power Output

FIG. 1 is a diagram illustrating a system 100 for forecasting solar power output configured in accordance with an embodiment of the technology. The system 100 includes a satellite 102, a satellite transmitter/receiver (transceiver) 106, and a meteorological data system 108 connected to the satellite transceiver 106. The system 100 also includes a solar power forecast system 110 connected to the meteorological data system 108 and to a photovoltaic plant (PV plant) 132 via a network 112. The PV plant 132 includes a photovoltaic array (PV array) 122 connected to a solar power inverter 120 and a PV plant control system 118. The PV plant control system 118 can be implemented by the inverter 120, by a string combiner, by a separate system, or any combination thereof. There can be horizon obstacles 128, such as trees 128a and mountains 128b, proximate to the PV array 122. Although the PV plant 132 is depicted as including a single PV array 122 and a single inverter 120, the PV plant can include multiple PV arrays 122 and/or multiple inverters 120.

The system 100 also includes an electrical power generator 116 (e.g., a coal, diesel, nuclear, or hydrological power plant) that is connected via the network 112 to a utility control system 114 of a utility. The electrical power generator 116 generates electricity that is transmitted over various electrical power transmission components 136, such as transmission and/or distribution substations and lines, to a load 124 (e.g., an industrial, commercial, and/or residential load). As described in more detail herein, an energy management system 126 manages demand for electrical power of the load 124. The electrical power generator 116, the load 124, and the PV plant 132 can be part of a utility control area 134 of the utility. Generally, a utility control area is a utility's service area, and can be any of various sizes (e.g., anywhere from hundreds to millions of square miles), and is not necessarily regularly shaped. The utility control area 134 can be connected to other utility control areas (not shown in FIG. 1), and interconnected utility control areas can provide and receive electrical power to and from each other. Although the utility control area 134 is depicted as including a single electrical power generator 116, a single load 124, and a single PV plant 132, a utility control area can include multiple electrical power generators 116, multiple PV plants 132, and/or multiple loads 124.

In operation, the PV array 122 converts the energy of sunlight directly into electricity via the photovoltaic effect. The PV array 122 generates direct current (DC) that is provided to the inverter 120. The inverter 120 converts the DC into alternating current (AC) that can be provided to the load 124 and/or that can be provided to the utility for transmission to other loads. The PV array 122 can experience varying irradiance due to clouds 104, horizon obstacles 128, and/or other factors. Decreases in irradiance can decrease the power generated by the PV array 122 and thus by the inverter 120. Decreases in power have to be matched by decreases in demand by the load 124 and/or by increases in power from electrical power generator 116, so as to avoid voltage sags and/or ACE penalties for violating power import/export limits.

The system 100 allows for such decreased power to be forecasted over multiple time frames. As described in more detail herein, the satellite 102 periodically provides satellite data (for example, satellite image data indicating atmospheric transmissivity) to the meteorological data system 108 via the satellite transceiver 106. The meteorological data system 108 uses the satellite data to predict average irradiance and other data over particular areas or locations at particular points in time. Such data predicted by the meteorological data system 108 is referred to herein as meteorological data. The meteorological data system provides the meteorological data to the solar power forecast system 110 via the network 112. The solar power forecast system 110 uses the meteorological data and other data, such as data regarding aspects of the PV plant 132, to forecast solar power output of the PV plant 132 at the particular points in time. The solar power forecast system 110 then provides the forecasted solar power output to the utility control system 114 via the network 112. The utility control system 114 can control the electrical power generator 116 to generate additional power to make up for any forecasted shortfall in solar power output of the PV plant 132. Additionally or alternatively, the utility can purchase power from other sources (e.g., the utility control system 114 can cause power to be purchased from other utilities) to make up for any forecasted shortfall.

The network 112 is illustrated as connecting the various systems of system 100 can be any network over which data can be transmitted (e.g., any combination of public and private networks, wired and wireless networks, and/or any suitable network). Although shown as a single network 112, those of skill in the art will understand that the system 100 can include multiple networks 112 that may or may not be interconnected. For example, the utility control system 114 can communicate with the electrical power generator 116 over a private network that is not accessible to other systems. Moreover, there may be a network between the inverter 120 and the PV plant control system 118, a network between the PV plant control system 118 and the energy management system 126, and a network between the energy management system 126 and the load 124.

Each of the meteorological data system 108, the solar power forecast system 110, the utility control system 114, the PV plant control system 118, and the energy management system 126 can include one or more apparatuses for performing the functions ascribed to each respective system and/or other functions described herein. The apparatus can be a computing system or other suitable apparatus. Moreover, the functions described herein may be distributed amongst various apparatus. For example, components such as DC optimizer modules could be installed on each photovoltaic module, or in string combiners connected to multiple photovoltaic modules. The DC optimizer modules could be performing functions for adjusting a maximum power point tracking algorithm as described herein. The PV plant control system 118, the inverter 120, the DC optimizer modules, and/or the string combiners could solar power forecast data and respond accordingly to such data (e.g., the DC optimizer modules could control an maximum power point tracking algorithm for the associated photovoltaic module as described herein).

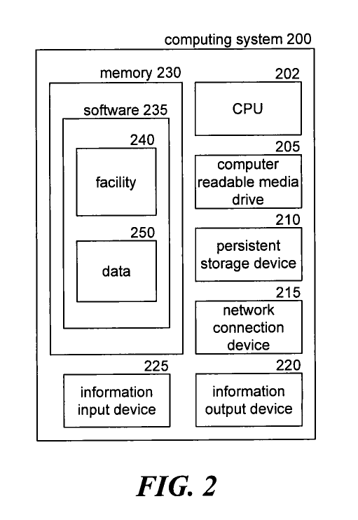

FIG. 2 is a block diagram illustrating a computing system 200 that can implement the meteorological data system 108, the solar power forecast system 110, the utility control system 114, the PV plant control system 118, and/or the energy management system 126. The computing system 200 includes a memory 230. The memory 230 includes software 235 incorporating both a facility 240 and data 250 typically used by the facility 240. The facility 240 performs certain of the methods or functions described herein, and may include components, subcomponents, or other logical entities that assist with or enable the performance of some or all of these methods or functions. The data 250 includes data used by the facility 240 to perform various functions. For example, in the case of the solar power forecast system 100, the data 250 can include meteorological data, PV plant data, and forecasted solar power output data. While items 240 and 250 are stored in memory 230 while being used, those skilled in the art will appreciate that these items, or portions of them, may be transferred between memory 230 and a persistent storage device 210 (for example, a magnetic hard drive, a tape of a tape library, etc.) for purposes of memory management, data integrity, and/or other purposes.

The computing system 200 further includes one or more central processing units (CPU) 202 for executing software 235, and a computer-readable media drive 205 for reading information or installing software 235 from tangible computer-readable storage media, such as a floppy disk, a CD-ROM, a DVD, a USB flash drive, and/or other tangible computer-readable storage media. The computing system 200 also includes one or more of the following: a network connection device 215 for connecting to the network 112, an information input device 220 (for example, a mouse, a keyboard, etc.), and an information output device 225 (for example, a display). The computing system 200 can also include components other than those described herein.

The systems and components described in FIG. 2 and elsewhere herein may comprise software, firmware, hardware, or any combination(s) of software, firmware, or hardware suitable for the purposes described herein. Software and other components may reside on servers, workstations, personal computers, and other devices suitable for the purposes described herein. In other words, the software and other components described herein may be executed by a general-purpose computer, e.g., a server computer. Furthermore, aspects of the system can be embodied in a special purpose computer or data processor that is specifically programmed, configured, or constructed to perform one or more of the computer-executable instructions explained in detail herein. The system can also be practiced in distributed computing environments where tasks or components are performed by remote processing devices, which are linked through a communications network, such as a Local Area Network (LAN), Wide Area Network (WAN), or the Internet. In a distributed computing environment, program components may be located in both local and remote memory storage devices.

Data structures described herein may comprise computer files, variables, programming arrays, programming structures, or any electronic information storage schemes or methods, or any combinations thereof, suitable for the purposes described herein. Data and software may be stored or distributed on computer-readable media, such as computer-readable storage media and/or tangible media, including magnetically or optically readable computer discs, hard-wired or preprogrammed chips (e.g., EEPROM semiconductor chips), or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme).

### 3. Processes for Forecasting Solar Power Output

In forecasting solar power output, there may be two different time frames of interest. A first time frame may be several hours from the time of the forecast, such as from about one to about twenty-four hours, or in some cases more typically from about two to about twelve hours. It can be important to forecast solar power output in this time frame so as to allow a utility enough time to make decisions, such as to increase power production purchase and/or to purchase additional power to make up for any forecasted shortfall in solar power output. A second time frame may be one or more minutes from the time of the forecast, such as from about one minute to about one hour from the time of the forecast. Such a forecast can allow for operations to mitigate effects of a forecasted shortfall in solar power output at, for example, the local level.

A. Forecasting Solar Power Output for the First Time Frame

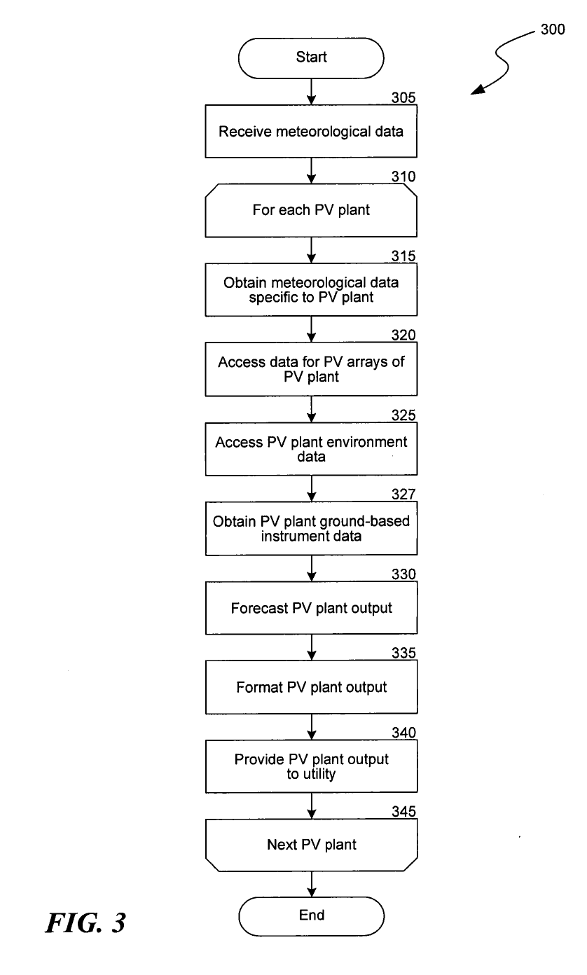

FIG. 3 is a flow diagram of a process 300 for forecasting solar power output over the first time frame. The process 300 is described as performed by the solar power forecast system 110. However, the process 300 can be performed by any of the other systems described herein, or by any suitable apparatus or system with appropriate hardware (e.g., central processing unit (CPU), etc.), firmware (e.g., logic embedded in microcontrollers, etc.), and/or software (e.g., stored in volatile or non-volatile memory). The solar power forecast system 110 can perform the process 100 substantially continuously or periodically (e.g., every 15 minutes to every 60 minutes).

The process 300 begins at step 305, where the solar power forecast system 110 receives meteorological data from the meteorological data system 108. The satellite 102 can transmit satellite data to the meteorological data system 108 periodically (e.g., every six hours). The meteorological data system 108 can use the satellite data as well as other data (e.g., data pertaining to wind speeds, humidities, cloud creation, updrafts, upwelling, and/or other factors) in a predictive model to predict atmospheric transmissivity and/or other information at various future points of time. The meteorological data system 108 can produce the meteorological data periodically (e.g., every 30 minutes) and after producing the meteorological data, transmit the meteorological data to the solar power forecast system 110.

The meteorological data can include several items of data, such as predicted global horizontal irradiance data, estimated ambient temperate data, and solar zenith data, for multiple locations (e.g., locations covering the utility control area 132 and other utility control areas) at multiple future points of time (e.g., at every hour from two to twelve hours into the future). Global horizontal irradiance is the total irradiance on a flat surface at a particular location. Global horizontal irradiance includes direct irradiance and diffuse irradiance. The ambient temperate data is an estimate of the ambient (surface) temperature at a particular location. Solar zenith data indicates the position of the sun in the sky with respect to a location. The meteorological data can include these items of data and other items of data. Additionally or alternatively, the meteorological data can include data from which the solar power forecast system 110 can derive the global horizontal irradiance data, the estimated ambient temperate data, and the solar zenith data.

In step 310, the solar power forecast system 110 identifies the PV plants 132 for which solar power output is to be forecasted, and selects one of the identified PV plants 132. For example, the solar power forecast system 110 can forecast solar power output for each PV plant 132 located in an area for which the solar power forecast system 110 receives meteorological data from the meteorological data system 108. In step 315, the solar power forecast system 110 obtains from the meteorological data received in step 305 meteorological data that is specific to the selected PV plant. In step 320, the solar power forecast system 110 accesses data for the PV arrays 122 at the PV plant 132, referred to herein as PV array data. The PV array data can include data pertaining to the orientation of the PV array 122 (e.g., the array tilt and the array azimuth) as well as the structure of the PV array 122 (e.g., the PV array 122 can be on an open rack mount or on a roof, and the structure data can indicate such mounting as well as pertinent mount details).

The PV array data can also include data pertaining to solar modules of the PV array 122, referred to as solar module parameter data. The solar module parameter data can include efficiency data, efficiency temperature coefficient data, and nominal operating cell temperature data for the solar modules of the PV array 122. The efficiency data can indicate an overall efficiency of the PV array 122, the efficiency temperature coefficient data can indicate an amount that the voltage, current, and/or power output of a solar cell changes due to a change in the cell temperature, and the nominal operating cell temperature data can indicate a temperature at which the solar cells in the solar modules of the PV array 122 operate.

In step 325, the solar power forecast system 110 accesses data for the PV plant 132 environment, referred to as PV plant environment data. The PV plant environment data can include data regarding horizon profile data, which takes into account horizon obstacles 128 in the hemispherical field of view of the PV array 122 that may block sunlight at any given time of day or time of year. As previously noted, such horizon obstacles 128 can include trees 128a and/or mountains 128b, as well as other obstructions, such as buildings, towers, power lines, flagpoles, and/or other obstructions. In some embodiments, satellite data (e.g., pictures taken by satellites) is used to determine the horizon profile data. For example, a satellite image created at a specific time can reveal that a horizon obstacle 128 casts a specific shadow. The time at which the satellite image was created provides the solar angle, from which the solar power forecast system 110 can derive the position of the sun.

The solar power forecast system 110 can use the sun position to determine the height of the horizon obstacle 128, and use the horizon obstacle 128 height to determine whether the horizon obstacle 128 will cast a shadow onto the PV array 122 at any given time. The solar power forecast system 110 can thus determine whether irradiance at the PV array 122 will be decreased due to horizon obstacles 128 at any given time, and if so, the extent of the decrease. The horizon profile data can be provided by a satellite and/or derived from satellite data, and can be provided in real-time or such that the horizon profile data is generally up-to-date and accurately reflects actual conditions. Additionally or alternatively, the horizon profile data can be provided by a site visit, by instruments at the PV plant 132, and/or by other means.

The PV plant environment data can also include data regarding ground albedo, referred to as albedo data. Ground albedo indicates the extent to which ground reflects light from the Sun. For example, snow can have a high albedo. Light reflecting off snow can increase the irradiance at the PV array 122. For example, some PV arrays are tilted at “latitude tilt”, meaning that the tilt angle of PV array 122 may be the same as the site latitude. For example, for sites at 45 degrees latitude, the PV array 122 may be tilted at an angle of approximately 45 degrees. In such an orientation, when there is snow proximate to the PV array 122, the potential exists for light reflecting off the snow to increase the irradiance at the PV array 122 by a large factor, (e.g., the reflected light may double the irradiance at the PV array 122). The albedo data for the PV array 122 can vary from day to day and/or from season to season. The albedo data can be provided by a satellite and/or derived from satellite data, and can be provided in real-time or such that the albedo profile data is generally up-to-date and accurately reflects actual conditions. Additionally or alternatively, the albedo data can be provided by a site visit, by instruments at the PV plant 132, and/or by other means.

In step 330, the solar power forecast system 110 forecasts the PV plant 132 output using the meteorological data, the PV array data, and the PV plant environment data. The solar power forecast system 110 can calculate a plane of array irradiance. The solar power forecast system 110 can calculate the plane of array irradiance using the global horizontal irradiance data, the array orientation data, the horizon profile data, and the albedo data.

As known to those of skill in the art, the sun moves in a vertical direction in the sky and also has an azimuthal movement. Solar azimuth is the angle between a line pointing north and the translation onto the ground of a line pointing toward the sun. Solar azimuth is measured clockwise from north. The solar azimuth can affect whether or not there is incident direct irradiance at the PV array 122. For example, in certain locations (e.g., northern latitudes), the PV array 122 may be facing due south. At certain times (for example, at sunrise in the summer) at such locations, the solar azimuth may be less than 90 degrees, meaning that the sun is behind the PV array 122 and that there is no direct irradiance at the PV array 122. In such configurations, there is no direct irradiance at the PV array until the solar azimuth is greater than 90 degrees. In some embodiments, the solar power forecast system 110 takes into account the varying solar azimuth in calculating the plane of array irradiance. In some embodiments, instead of accounting for the varying solar azimuth in calculating the plane of array irradiance, the effect of the varying solar azimuth is included in the global horizontal irradiance data.

In calculating the plane of array irradiance, the solar power forecast system 110 can use a resolution based upon the size of the PV plants 132 that are expected to be significant (e.g., the PV plants 132 whose output can impact utility dispatch operation) and the need to estimate a ramp rate caused by a cloud edge. For example, the solar power forecast system 110 can use a resolution of one computer pixel is equivalent to anywhere from about one hundred meters to about several kilometers as a suitable resolution.

Also as known to those of skill in the art, the efficiency of a solar cell can decrease as the solar cell temperature increases. The solar power forecast system 110 can account for this relationship by calculating an estimate of the operating temperature of the PV array 122. The solar power forecast system 110 can estimate the operating temperature by using the estimated ambient temperature data and the nominal operating cell temperature data. The solar power forecast system 110 can also use data regarding the structure of the PV array 122 to calculate the estimated operating temperature of the PV array 122. For example, if the PV array 122 has an open rackmount configuration in which the solar modules are standing on racks, the PV array 122 temperature under sunlight will be different from that of a PV array 122 configured flush on a roof. Accordingly, taking the PV array 122 structure into account can result in a more accurate estimated operating temperature of the PV array 122.

The solar power forecast system 110 can then calculate a forecast efficiency for the PV plant 132 using the estimated operating temperature of the PV array 122, the efficiency data, and the temperature coefficient data. The solar power forecast system 110 can then calculate a power output for the PV plant 132 using the plane of array irradiance and the calculated forecast efficiency. The solar power forecast system 110 can calculate a power output at a particular point in time (e.g., 240 kW at six hours in the future) or the average power output over a period (e.g., 220 kW for one hour six hours in the future).

In step 335, the solar power forecast system 110 formats the PV plant 132 power output so that it may be used by the utility (e.g., by utility personnel such as dispatchers). The solar power forecast system 110 can provide PV plant 132 power output in various formats. For example, the solar power forecast system 110 can produce a two-dimensional map of the relevant geographical area with locations of PV plants 132 marked and an overlay of PV plant 132 power output. Additionally or alternatively, the solar power forecast system 110 could produce a color-coded thermal map of PV output forecasts over the relevant geographical area (e.g., red at or above a first threshold value, yellow at or above a second threshold value to below the first threshold value, and green below the second threshold value.

The solar power forecast system 110 can provide PV plant 132 power output for various windows of time in the future. For example, the solar power forecast system 110 can provide average PV plant 132 power output for a window of 30 minutes that is six hours in the future. The window can correspond to a typical utility real-time dispatch load forecast window. The solar power forecast system 110 can provide a two-dimensional map for each time point (e.g., for each time point in the future, such as anywhere from two to 12 hours ahead). The solar power forecast system 110 can produce a separate map for each time point (e.g., a map for six hours into the future, a map for seven hours into the future, a map for eight hours into the future, etc.)

As another example, the solar power forecast system 110 can produce a time series strip chart of PV plant 132 power output (e.g., showing predicted PV plant 132 power output over time). As another example, the solar power forecast system 110 can produce a plot with time on the horizontal axis and plane of array irradiance on a first vertical axis. The plot can also show PV plant 132 power output using a second vertical axis. Those of skill in the art will understand that the solar power forecast system 110 can provide the output of the solar power forecasting in various ways and using various techniques.

As another example, the solar power forecast system 110 could produce an indication of the PV plant 132 output that takes into account the materials used in the solar cells of the PV array 122. For example, solar cells made of cadmium telluride may absorb light of a first range of wavelengths most effectively, and solar cells made of crystalline silicon may absorb light of a second range of wavelengths most effectively. The solar power forecast system 110 could take such material properties into account in forecasting the PV plant 132 output.

In step 340 the solar power forecast system 110 provides the PV plant 132 power output (as formatted) to the utility control system 114 via the network 112. In step 345 the solar power forecast system 110 selects a next PV plant 132 for which a power output is to be forecasted. The solar power forecast system 110 then repeats steps 315 to 340 for the next PV plant 132. The solar power forecast system 110 repeats these steps for each PV plant 132 until the solar power forecast system 110 has forecasted solar power output for each PV plant 132 (e.g., each PV plant 132 located in an area for which the solar power forecast system 110 receives meteorological data from the meteorological data system 108). After step 345 the process 300 concludes. As previously noted, the solar power forecast system 110 can repeat the process 300 periodically, such as every 30 minutes to every four hours.

One advantage of the techniques described herein is that although the solar power forecast system 110 may not be able to affect the actual amount of power produced by the PV plant 132, the solar power forecast system 110 can provide more certainty as to the amounts of power that the PV plant 132 will produce in the future. Such greater certainty can benefit the utility by allowing utility personnel to better plan how to provide power to various loads 124, such as by contracting for the delivery of power in advance (which can be relatively inexpensive) and thereby avoiding having to purchase power on the spot market (which can be relatively expensive).

Another advantage of the systems and methods described herein is that the solar power forecast system 110 can predict PV plant 132 power output according to the different materials that PV arrays 122 are made out of. For example, certain PV plants 132, such as those in locations where there are few if any physical constraints upon the size of the PV plants 132 (e.g., PV plants 132 in deserts), may use solar cells made out of cadmium telluride. Solar cells made out of cadmium telluride absorb light having a wavelength in a first range of wavelengths. Other PV plants 132, such as those in locations having physical constraints upon the size of the PV plants 132 (e.g., PV plants 132 on roofs of industrial and/or commercial facilities), may use solar cells made out of material that has a higher efficiency than cadmium telluride, such as silicon. Solar cells made out of silicon absorb light having a wavelength in a second range of wavelengths. The solar power forecast system 110 can take such differing wavelengths into account in predicting the PV plant 132 power output, and provide PV plant 132 output that differentiates such wavelengths.

Another advantage of the techniques described herein is that because they provide greater certainty to utilities as to the amount of power produced by PV plants 132, they can pave the way for higher penetration rates for PV plants 132 on utility grids.

B. Forecasting Solar Power Output for the Second Time Frame

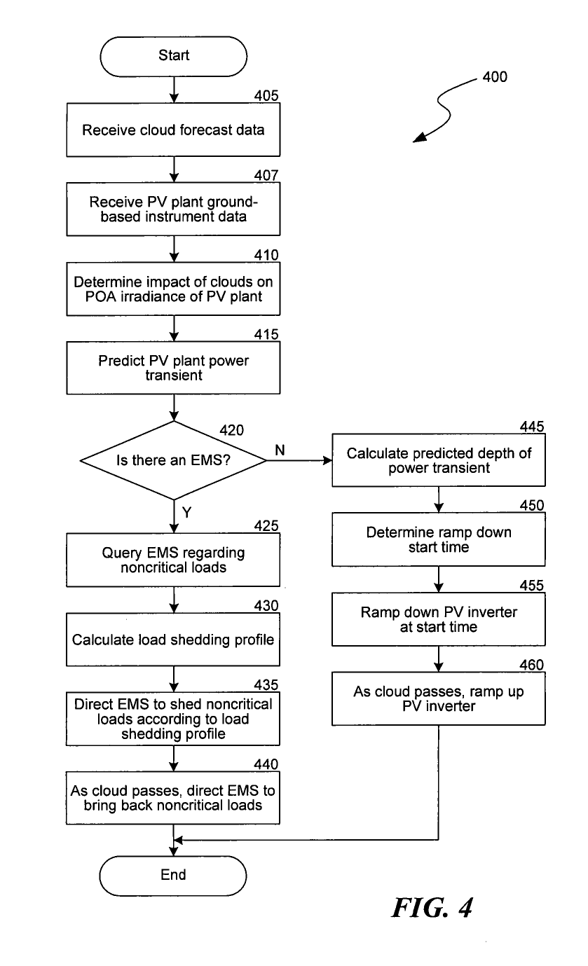

As previously noted, it can be important to forecast solar power output in a second time frame that may be one or more minutes from the time of the forecast, such as from about one minute to about one hour from the time of the forecast. FIG. 4 is a flow diagram of a process 400 for forecasting solar power output over such a second time frame and performing an operation to mitigate the effects of reduced irradiance due to the passage of clouds over a PV plant. The process 400 is described as performed by the PV plant control system 118. The process 400 can be performed by any suitable apparatus or system with appropriate hardware (e.g., central processing unit (CPU), etc.), firmware (e.g., logic embedded in microcontrollers, etc.), and/or software (e.g., stored in volatile or non-volatile memory). The PV plant control system 118 can perform the process 400 substantially continuously or periodically (e.g., every 30 seconds to every ten minutes).

The process 400 begins at step 405 where the PV plant control system 118 receives cloud forecast data from the meteorological data system 108 via the network 112. The cloud forecast data can include cloud location and shape data, cloud velocity data, cloud transmissivity data, and cloud evolution data (e.g., how the cloud's parameters change over time). The cloud forecast data may be normalized to account for such factors. For example, a high normalized value may indicate a cloud that is likely to block a majority of irradiance (e.g., a dark cumulus cloud) whereas a low normalized value may indicate a cloud that is unlikely to block all irradiance (e.g., a wispy cirrus cloud). The cloud forecast data may be for a point in time anywhere from one minute in the future to one hour in the future. The PV plant control system 118 can use cloud forecast data that is centered around the PV plant 132 with a radius of anywhere from about one kilometer to about 50 kilometers. The PV plant control system 118 can use a resolution sufficient to determine where cloud shadows are relative to the PV array 122. For example, the PV plant control system 118 can use a resolution of one computer pixel is equivalent to anywhere from about one meters to about 500 meters as a suitable resolution.

In step 410 the PV plant control system 118 determines that the tracked clouds will cast a shadow on the PV array 122 and determines the impact the clouds will have on the plane of array irradiance at the PV array 122. The PV plant control system 118 can receive the plane of array irradiance data from the solar power output forecast system 110. Additionally or alternatively, the PV plant control system 118 can receive meteorological data from the meteorological data system 108 and calculate the plane of array irradiance. Additionally or alternatively, the PV plant control system 118 can determine the plane of array irradiance using irradiance measurements taken at the PV array 122.

In step 415 the PV plant control system 118 predicts the PV plant 132 power transient using the determined impact on the plane of array irradiance at the PV array 122. A power transient can be a decrease in PV plant 132 power output, and the PV plant control system 118 can quantify the power transient (e.g., the predicted decrease in power, the rate at which the PV plant 132 power output decreases, the duration of the power transient, etc).

In step 420, the PV plant control system 118 determines whether there is an energy management system 126 for a load 124 for which the PV plant 132 is providing power. For example, if the load 124 is an industrial or commercial load, the load 124 may have an energy management system 126 that manages demand for electrical power by the load 124. If there is an energy management system 126 for the load 124, the process 400 continues to step 425, where the PV plant control system 118 queries the energy management system 126 regarding noncritical loads. For example, a commercial load 124 may have significant noncritical refrigeration load or heating load. The energy management system 126 may be able to interrupt the delivery of electrical power to such refrigeration load and/or heating load for a short period of time without significant effects.

In step 430 the PV plant control system 118 calculates a load shedding profile to closely match the predicted PV plant power transient. In step 435, the PV plant control system 118 directs the energy management system 126 to shed noncritical loads according to the load shedding profile. In step 440, as the cloud passes, the PV plant control system 118 directs the energy management system 126 to bring back the noncritical loads. One advantage of this technique is that since the power output of the PV plant 132 is predicted to decrease (which, from the utility perspective, appears as an increase in load), the shedding of loads via the energy management system 126 allows the load 124 to correspondingly decrease. The decrease in load 124 can effectively cancel out the decrease in PV plant 132 power output. Accordingly, the utility would generally not be affected by the decrease in PV plant 132 power output.

Returning to step 420, if there is not an energy management system 126 for the load 124, the process 400 continues to step 445, where the PV plant control system 118 calculates a predicted depth of the PV plant power transient. In step 450, the PV plant control system 118 determines a time at which the solar power inverter 120 should start ramping down the maximum power point tracker (MPPT) in order to maintain a ramp rate that is acceptable. An acceptable ramp rate refers to a decrease in power production that allows the utility sufficient time to take steps to mitigate the decrease in PV plant 132 power output. For example, the inverter 120 should ramp down at a rate that permits the utility to ramp up similarly, so as to avoid propagating voltage transients to the load 124. This approach causes the inverter 120 to produce less power than it could, but reduces the rate of change of the demand by the load 124, which can be more financially advantageous to an operator of the PV plant 132 or the load 124. In step 455, the PV plant control system 118 directs the inverter to ramp down at the start time. At step 460, as the cloud passes, the PV plant control system 118 directs the solar power inverter to ramp up. After steps 440 or 460 the process 400 concludes.

### 4. Other Sources of Meteorological Data

Ground-based instruments such as irradiance meters or cameras can be used to provide or supplement meteorological data or to confirm predictions made by satellite data. For example, cameras located in PV plant 132 may capture images of the sky, and such images may be used to derive global horizontal irradiance data and/or plane or array irradiance data. The cameras may also be used to capture cloud characteristics, such as cloud spacing, cloud movement direction, cloud patterns (e.g., wispy, mottled, or solid), cloud optical density, and the like. Other data sources such as instruments in weather balloons may be used for irradiance estimates as well as to detect cloud characteristics. The use of ground-based measurements and/or other non-satellite measurements may be used either a stand-alone method, or a hybrid approach where it is used to validate or provide a confidence interval for the forecasted data.

### 5. Use of Solar Power Forecasts for Diagnostic Purposes

It can be difficult to ascertain whether everything in a PV plant is working properly. For example, PV arrays in a PV plant may become degraded or the PV plant can suffer from other problems that can reduce power output. Although a PV plant's actual power output is known, the PV plant may not have irradiance measurements, and thus may not be able to determine how much power the PV plant should be theoretically capable of producing. Accordingly, it would be useful to be able to diagnose potential problems in a PV plant without requiring irradiance measurements from which a theoretical PV plant output can be derived.

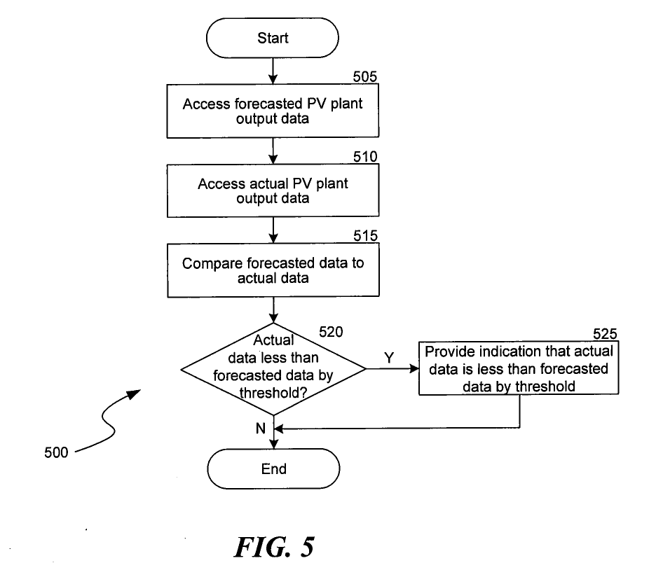

FIG. 5 is a flow diagram of the process 500 for diagnosing potential problems with a PV plant in accordance with an embodiment of the technology. The process 500 begins at step 505, where the computing system performing the process accesses forecasted PV plant output data. The forecasted PV plant power output data may be data determined as a result of the processes 300 or 400 of FIG. 3 or 4. The forecasted PV plant power output data may be for a particular timeframe, such as for 30 minutes, 60 minutes, two hours, or any suitable timeframe. At step 510, the computing system accesses actual PV plant power output data. Such actual PV plant power output data is the actual output of the PV plant over the same timeframe as the forecasted PV plant power output data obtained in step 505. At step 515, the computing system compares the forecasted PV plant power output data to the actual PV plant power output data. At decision step 520, the computing system determines whether the actual data is less than the forecasted data by a predetermined threshold. For example, the predetermined threshold may be set so as to account for forecasting errors, prediction errors, measurement errors, or other aspects that could affect either the forecasted data or the actual data. If the actual data is less than the forecasted data by the predetermined threshold, the process 500 continues at step 525, where the computing system provides an indication that the actual data is less than the forecasted data by the predetermined threshold. Such an indication can indicate a potential problem with the PV plant, such as a string of PV modules that are malfunctioning. The process 500 then concludes.

The techniques described herein can be used to forecast what the PV plant's power output should have been with a fair degree of confidence. The forecasted PV plant output can be compared with the actual PV plant output to see if the actual PV plant output is much less than the forecasted PV plant output. This can allow a PV plant operator to determine whether there is a problem with the PV plant that is reducing the output. Accordingly, the techniques described herein can be used diagnostically and can lead to improvements in the economic viability of the PV plant for the operator.

### 6. Use of Solar Power Forecasts for MPPT Tuning

Solar power inverters use a maximum power point tracking (MPPT) algorithm to optimize the power produced by a PV array. Typically, an MPPT algorithm is tuned to work across a range of conditions (e.g., from completely overcast to sunny). The solar power forecast data can be used to adjust the gains or the tuning parameters of the MPPT algorithm according to the forecast. For example, an MPPT algorithm may use an approach referred to as perturb and observe to find the maximum power point. Such perturbing may occur as frequently as every second, and may result in loss of power production. Accordingly, it would be useful to be able to adjust an MPPT algorithm in ways that reduce or minimize loss of power production.

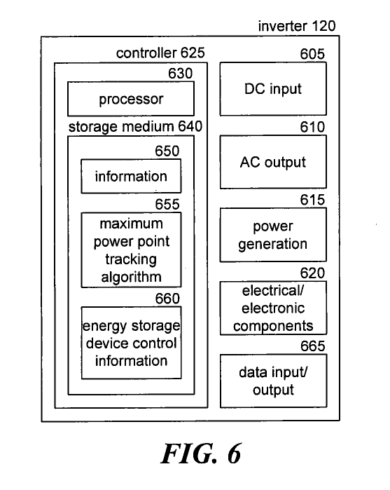

FIG. 6 is a block diagram illustrating components of the solar power inverter 120 of FIG. 1, as configured in accordance with an embodiment of the technology. The solar power inverter 120 includes a DC input component 605 that receives DC produced by the arrays 122. The solar power inverter 120 also includes power generation component 615, which can include insulated gate bipolar transistors (IGBTs) that transform DC into AC for output by an AC output component 610. The solar power inverter 120 further includes various other electrical and/or electronic components 620, such as circuit boards, capacitors, transformers, inductors, electrical connectors, and/or other components that perform and/or enable performance of various functions associated with the conversion of DC into AC and/or other functions described herein. The solar power inverter 120 can also include a data input/output component 665, which can include a wireless device and/or other components that provide data input/output functionality and/or connection to a wired or wireless network (e.g., a modem, an Ethernet network card, Gigabit Ethernet network card, etc.).

The solar power inverter 120 further includes a controller 625, which includes a processor 630 and one or more storage media 640. For example, the controller 625 can include a control board having a digital signal processor (DSP) and associated storage media 640. As another example, the controller 625 can include a computing device (for example, a general purpose computing device) having a central processing unit (CPU) and associated storage media. The storage media 640 can be any available media that can be accessed by the processor 630 and can include both volatile and nonvolatile media, and removable and non-removable media. By way of example, and not limitation, the storage media 640 can include volatile and nonvolatile, removable and non-removable media implemented via a variety of suitable methods or technologies for storage of information. Storage media include, but are not limited to, RAM, ROM, EEPROM, flash memory or other memory technology, or any other medium (for example, magnetic disks) which can be used to store the desired information and which can accessed by the processor 630.

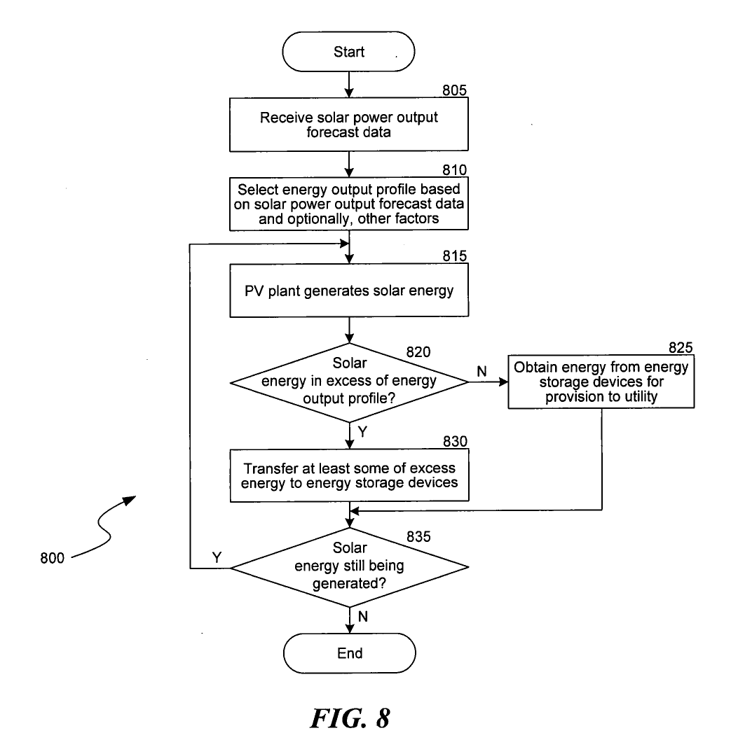

The storage media 640 stores information 650. The information 650 includes instructions, such as program modules, that are capable of being executed by the processor 630. Generally, program modules include routines, programs, objects, algorithms, components, data structures, and so forth, which perform particular tasks or implement particular abstract data types. The information 650 also includes data, such as values stored in memory registers, which can be accessed or otherwise used by the processor 630. The processor 630 can use the information 650 to perform various functions or cause various functions to be performed. The storage medium 640 also stores a maximum power point tracking algorithm 655. As described in more detail herein, the processor 630 can implement the maximum power point tracking algorithm to affect an amount of power produced by PV array 122. The storage medium 640 also stores energy storage device control information 660, which the processor 630 can use to control transfer of energy to and from an energy storage device, as described in more detail herein with respect to FIG. 8. The solar power inverter 120 can also include components that are not illustrated in FIG. 6.

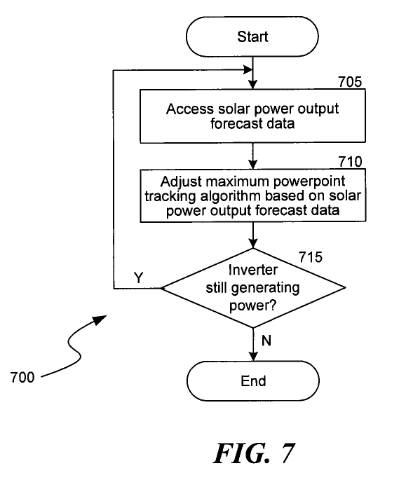

FIG. 7 is a flow diagram of a process 700 for adjusting an MPPT algorithm based on a solar power forecast in accordance with an embodiment of the technology. The process 700 is described as being performed by the controller 630 of the solar power inverter 120, but the process 700 may be performed by any suitable apparatus. For example, the process 700 could be performed by a DC optimizer module (associated with an individual photovoltaic module) or a string combiner (associated with multiple photovoltaic modules). The process 700 begins at step 705, where the controller 630 accesses solar power output forecast data. For example, the controller 630 may access solar power output forecast data for the various timeframes described herein that is received from the solar power forecast system 110. At step 710, the controller 630 adjusts the maximum power point tracking algorithm 655 based upon the solar power output forecast data.

For example, if the forecast for a particular time period is sunny, the controller 630 can decrease the frequency with which the controller 630 moves away from the maximum power point during that particular time period (e.g., from once per second (or more frequently) to once per minute (or less frequently)). Such a frequency decrease can result in increased power production of the PV array. As another example, if the forecast for a particular time period is for a cloud to pass over the PV arrays, the solar power inverter can adjust the MPPT algorithm to account for an expected drop in production (e.g., by controlling the voltage point). As another example, the controller 630 could change MPPT algorithms based on the forecasts (e.g., to use a MPPT algorithm tuned for sunny conditions when the forecast is such, or to use a MPPT algorithm tuned for overcast conditions when the forecast is such). As another example, the controller 630 could set gains for response times or ramps for the MPPT algorithm.

In some embodiments, the forecast data also includes cloud forecast data, and the controller 630 takes the cloud forecast data into account in adjusting or controlling the MPPT algorithm. For example, clouds might be dense and well defined, which would give a sharp edge to the effect upon irradiance at the photovoltaic modules. As another example, the clouds might be disperse and soft-edged, which would produce a softer effect upon irradiance at the photovoltaic modules.

At step 715, it is determined whether the solar power inverter 120 is still generating power. If so, the process 700 returns to step 705, and step 705, 710, and 715 repeat. If not, the process 700 then concludes.

### 7. Use of Solar Power Forecasts for Controlling Transfer of Energy to and from Energy Storage Devices

PV plants can have energy storage devices and an energy storage device controller. The PV plant can use the energy storage devices to store excess power generated by the PV plant and to release the stored power to make up for shortfalls in PV plant power production. The energy storage device controller can control the transfer of energy to and from the energy storage device. The functionality of the energy storage device controller could be provided by a solar power inverter. For example, a PV plant can include batteries and a battery controller that controls the charging and discharging of the batteries. As another example, a PV plant could include a fuel cell and a fuel cell controller that controls transfer of energy to and from the fuel cell.

The energy storage device controller could utilize solar power forecasts to optimize the transfer of energy to and from the energy storage devices in various ways. FIG. 8 is a flow diagram of a process 800 for controlling an energy storage device based on a solar power forecast in accordance with an embodiment of the technology. The process 800 begins at step 805, where the energy storage device controller accesses solar power output forecast data. For example, the energy storage device controller could receive solar power forecasts from the solar power forecast system 110 for the various time frames described herein. At step 810, the energy storage device controller controls transfer of energy to or from the energy storage device based upon the solar power output forecast data.

For example, an operator of the PV plant could commit to providing less than the PV plant's average power to a utility. The PV plant could then store the excess generated power in the energy storage devices. If PV plant output is forecasted to drop below the PV plant's average power, then the energy storage device controller can prepare to transfer energy from the energy storage devices to the utility. Such preparation can allow the energy storage device controller to be able to transfer energy from the energy storage devices at the time of the forecasted drop. Accordingly, the energy storage device controller can assist the PV plant in providing the committed-to power to the utility. After the PV plant output shortfall concludes, the energy storage device controller can transfer energy to the energy storage devices.

Another example may be in applying energy balance control to the energy storage. In this technique, the output power to the utility is the sum of the PV power plus energy storage power, and the energy storage is controlled to cause the PV plant output profile to match some desired trajectory, which may be a smooth “clear sky” type of output, or a shifted output to a later (more economically favorable) time of day. One advantage to being able to apply this type of control is the knowledge of the average input to the energy storage from the PV plant, and the irradiance forecasts over various time frames can provide such knowledge.

If the PV plant output is forecasted to not drop over a particular time window, then the energy storage device controller can transfer energy to the energy storage device at an optimal rate over the particular time window. For example, charging a battery above a certain rate can shorten the battery life. Therefore, where the energy storage devices are batteries, it can be desirable to charge the batteries below the certain rate, so as to avoid unnecessarily decreasing the batteries' service lives. Accordingly, a battery controller can utilize knowledge that the PV plant output is forecasted to not drop over a particular time window to optimally charge the batteries during the particular time window. In contrast, if the PV plant output is forecasted to drop again at a future time, the battery controller can adjust the battery charging so as to maximize the battery charging before the future time, so that the batteries can provide power to the utility at the future time. Accordingly, the techniques described herein can be used to control the transfer of energy to and from energy storage devices, such as batteries, in ways that minimizes the financial impact upon the operator of the PV plant.

After step 810, the process 800 continues to decision step 815, where it is determined whether the energy storage device controller is still controlling transfer of energy to and from the energy storage device. If so, the process 800 returns to step 805. If not, the process 800 then concludes.

### 8. Conclusion

Unless the context clearly requires otherwise, throughout the description and the claims, the words “comprise,” “having,” “include,” and the like, and conjugates thereof, are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description that are singular or plural may also be deemed to include plural or singular forms, respectively. The word “or,” in reference to a list of two or more items, covers all of the following interpretations of the word: any of the items in the list, all of the items in the list, and any combination of the items in the list. The terms “based on,” “according to,” and the like are not exclusive and are equivalent to the term “based, at least in part, on,” “at least according to,” or the like and include being based on, or in accordance with, additional factors, whether or not the additional factors are described herein.

The above detailed description of examples of the technology is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

Any patents and applications and other references noted above, including any that may be listed in accompanying filing papers, are incorporated herein by reference. While certain aspects of the invention are presented below in certain claim forms, the applicant contemplates the various aspects of the invention in any number of claim forms. For example, aspects of the invention may be recited in means-plus-function claims under 35 U.S.C. §112, ¶ 6. (Any claims intended to be treated under 35 U.S.C. §112, ¶ 6 will begin with the words “means for.” Use of the term “for” in any other context is not intended to invoke treatment under 35 U.S.C. §112, ¶ 6.) Aspects of the invention may be embodied in other forms, such as computer-readable mediums or processor-readable mediums. Accordingly, the applicant reserves the right to add additional claims after filing the application to pursue such additional claim forms for other aspects of the invention.

From the foregoing, it will be appreciated that specific embodiments of the invention have been described herein for purposes of illustration, but that various modifications may be made without deviating from the spirit and scope of the invention. For example, although the processes 300 and 400 are described as using satellite data, data from ground-based instruments (e.g., cameras) may be used to detect cloud cover, cloud cover density, cloud direction, cloud velocity, and other cloud characteristics. As another example, data from other instruments (e.g., weather balloons) may be used for irradiance estimates as well as to detect cloud characteristics. As another example, instead of an prediction of global horizontal irradiance, an estimate of an atmospheric clearness can be utilized. As another example, the elements of one embodiment can be combined with other embodiments in addition to or in lieu of the elements of other embodiments. The following examples provide additional embodiments.

We claim:

1. A method of forecasting power output of a photovoltaic plant having a photovoltaic array, the method comprising:
receiving meteorological data that include, for each of multiple future times, a prediction of global horizontal irradiance for each of multiple locations, wherein—
the photovoltaic plant has a location corresponding to one of the multiple locations, and
the prediction of global horizontal irradiance is based upon satellite data;
determining, from the meteorological data, the predicted global horizontal irradiance for the location of the photovoltaic plant at a future time;
accessing array data for the photovoltaic array of the photovoltaic plant, wherein the array data includes at least one of a tilt of the photovoltaic array and an azimuth of the photovoltaic array;
calculating a predicted plane of array irradiance for the photovoltaic array at the future time based upon the predicted global horizontal irradiance and the array data; and
forecasting, by a computing system having a processor and a memory, a power output of the photovoltaic plant at the future time based on the predicted plane of array irradiance.

2. The method of claim 1 wherein the meteorological data further include, for each of one or more points of time in the future, an estimated ambient temperature for each of the multiple locations, wherein the array data further includes nominal operating cell temperature data of the photovoltaic array, and wherein the method further comprises:
determining, from the meteorological data, the estimated ambient temperature for the photovoltaic plant;
calculating an estimated operating temperature of the photovoltaic array based upon the estimated ambient temperature for the photovoltaic plant and the nominal operating cell temperature data; and
forecasting power output of the photovoltaic plant at the future time based on the predicted plane of array irradiance and the estimated operating temperature.

3. The method of claim 2 wherein the array data further includes structure data indicating a structure of the photovoltaic array, and wherein the method further comprises calculating an estimated operating temperature of the photovoltaic array based upon the estimated ambient temperature for the photovoltaic plant, the nominal operating cell temperature data, and the structure data.

4. The method of claim 1 wherein the array data further includes efficiency data indicating an overall efficiency of the photovoltaic array, and wherein the method further comprises forecasting power output of the photovoltaic plant at the future time based on the predicted plane of array irradiance, the estimated operating temperature, and the efficiency data.

5. The method of claim 1, further comprising:
accessing environment data for the photovoltaic plant, wherein the environment data includes horizon profile data; and
calculating a predicted plane of array irradiance based upon the predicted global horizontal irradiance, the array data, and the horizon profile data.

6. The method of claim 5, wherein the environment data further includes ground albedo data, and wherein the method further comprises calculating a predicted plane of array irradiance based upon the predicted global horizontal irradiance, the array data, the horizon profile data, and the ground albedo data.

7. The method of claim 5, wherein horizon profile data is based upon satellite data, and wherein the method further comprises:
determining that a horizon obstacle shades at least a portion of the photovoltaic array at the future time; and
calculating a predicted plane of array irradiance at the future time based upon the predicted global horizontal irradiance, the array data, and the determination that the horizon obstacle shades at least a portion of the photovoltaic array at the future time.

8. The method of claim 1, further comprising:
determining a solar azimuth of the sun at the future time; and
calculating a predicted plane of array irradiance based upon the predicted global horizontal irradiance, the array data, and the solar azimuth.

9. The method of claim 1, further comprising transmitting the power output of the photovoltaic plant at the future time to a utility control system.

10. The method of claim 1 wherein receiving meteorological data includes receiving first meteorological data at a first time, and wherein the method further comprises:
receiving second meteorological data at a second time that include, for each of multiple future times, a prediction of global horizontal irradiance for each of the multiple locations, wherein the prediction of global horizontal irradiance is based upon satellite data;
determining, from the second meteorological data, the predicted global horizontal irradiance for the location of the photovoltaic plant at a future time; and
calculating a predicted plane of array irradiance for the photovoltaic array at the future time based upon the predicted global horizontal irradiance and the array data; and
forecasting a power output of the photovoltaic plant at the future time based on the predicted plane of array irradiance.

11. The method of claim 1, further comprising:
accessing data indicating actual solar power output of the photovoltaic plant at the future time;
determining if the actual solar power output is less than the forecasted power output of the photovoltaic plant at the future time by a predetermined amount; and
providing an indication that the actual solar power output is less than the forecasted power output.

12. The method of claim 1 wherein the photovoltaic array includes multiple solar cells including material that absorb light of a range of wavelengths, and wherein the method further comprises forecasting a power output of the photovoltaic plant at the future time based on the predicted plane of array irradiance and the range of light wavelengths absorbed by the solar cell material.

13. A computing system for forecasting solar power output of a photovoltaic plant having a photovoltaic array, the computing system comprising:
a processor; and
a memory containing:
a predicted global horizontal irradiance for the photovoltaic plant at a future time, the predicted global horizontal irradiance based upon satellite data;
tilt data indicating a tilt of the photovoltaic array;
azimuth data indicating an azimuth of the photovoltaic array; and
a facility programmed to forecast solar power output of the photovoltaic plant at the future time, wherein the facility utilizes the predicted global horizontal irradiance, the tilt data, and the azimuth data to forecast solar power output of the photovoltaic plant at the future time.

14. The computing system of claim 13 wherein the memory further contains estimated ambient temperature for the photovoltaic plant, and wherein the facility also utilizes the estimated ambient temperature to forecast solar power output of the photovoltaic plant at the future time.

15. The computing system of claim 13 wherein the memory further contains horizon profile data for the photovoltaic plant, and wherein the facility also utilizes the horizon profile data to forecast solar power output of the photovoltaic plant at the future time.

16. The computing system of claim 13 wherein the memory further contains albedo data for the photovoltaic plant, and wherein the facility also utilizes the albedo data to forecast solar power output of the photovoltaic plant at the future time.

17. The computing system of claim 13 wherein the memory further contains solar azimuth data, and wherein the facility also utilizes the solar azimuth data to forecast solar power output of the photovoltaic plant at the future time.

18. The computing system of claim 13, further comprising a data input/output component, and wherein the facility is further programmed to transmit the forecasted solar power output of the photovoltaic plant at the future time to a utility control system via the data input/output component.

19. A computer-readable storage medium whose contents cause a computing system to perform a method of forecasting power output of a photovoltaic plant having a photovoltaic array, the method comprising:
utilizing 1) a prediction of global horizontal irradiance at the photovoltaic plant at a future time, wherein the prediction of global horizontal irradiance is based upon satellite data, 2) tilt data indicating a tilt of the photovoltaic array, and 3) azimuth data indicating an azimuth of the photovoltaic array to forecast power output of the photovoltaic plant at the future time; and
storing an indication of the forecasted power output of the photovoltaic plant at the future time.

20. The computer-readable storage medium of claim 19 wherein the method further comprises utilizing 4) an estimated ambient temperature for the photovoltaic plant to forecast power output of the photovoltaic plant at the future time.

21. The computer-readable storage medium of claim 19 wherein the method further comprises utilizing 4) horizon profile data to forecast power output of the photovoltaic plant at the future time.

22. The computer-readable storage medium of claim 19 wherein the method further comprises utilizing 4) albedo data to forecast power output of the photovoltaic plant at the future time.

23. The computer-readable storage medium of claim 19 wherein the method further comprises utilizing 4) solar azimuth data to forecast power output of the photovoltaic plant at the future time.

24. The computer-readable storage medium of claim 19 wherein the computing system is a first computing system and wherein the method further comprises transmitting the indication of the forecasted power output of the photovoltaic plant at the future time to a second computing system.

25. The computer-readable storage medium of claim 19 wherein the prediction of global horizontal irradiance at the photovoltaic plant at a future time is a first prediction of global horizontal irradiance at the photovoltaic plant at a first future time, wherein the satellite data is first satellite data, the indication is a first indication, and wherein the method further comprises:
receiving a second prediction of global horizontal irradiance at the photovoltaic plant at a second future time, wherein the second prediction of global horizontal irradiance is based upon second satellite data;
utilizing 1) the second prediction of global horizontal irradiance at the photovoltaic plant at the second future time, 2) the tilt data, and 3) the azimuth data to forecast power output of the photovoltaic plant at the second future time; and
storing a second indication of the forecasted power output of the photovoltaic plant at the second future time.

26. A tangible computer memory encoding a data structure, the data structure comprising:
first information specifying a forecasted global horizontal irradiance at a first location at a first time, the forecasted global horizontal irradiance derived from satellite data;
second information specifying a photovoltaic plant having a photovoltaic array at the first location; and
third information specifying an orientation of the photovoltaic array,
such that the data structure may be used by a computing system at a second time prior to the first time to calculate a prediction of solar power output of the photovoltaic plant at the first time.

27. A method of forecasting power output of a photovoltaic plant, the method comprising:
receiving cloud forecast data containing information about one or more clouds affecting a predetermined area, the predetermined area including a photovoltaic plant having a photovoltaic array;
utilizing the cloud forecast data to predict an effect of a cloud upon plane of array irradiance at the photovoltaic array of the photovoltaic plant; and
utilizing, by a computing system having a processor and memory, the predicted effect upon the plane of array irradiance to predict a power transient of the photovoltaic plant.

28. The method of claim 27 wherein receiving cloud forecast data includes receiving cloud forecast data containing information about cloud location, cloud transmissivity, cloud shape, and cloud velocity of the one or more clouds.

29. The method of claim 27 wherein receiving cloud forecast data includes:
receiving first cloud forecast data at a first time;
receiving second cloud forecast data at a second time; and
based upon the first and second cloud forecast data, determining that a cloud is likely to cover at least a portion of the photovoltaic array.

30. The method of claim 27 wherein the photovoltaic array is coupled to a load having an energy management system, and wherein the method further comprises:
based upon the predicted solar power transient, calculating a load shedding profile; and
providing the load shedding profile to the energy management system,
such that the energy management system may utilize the load shedding profile to reduce power required by the load.

31. The method of claim 27 wherein the photovoltaic array is coupled to a solar power inverter that generates power, and wherein the method further comprises:
calculating an expected depth of the power transient;
determining a time at which to start ramping down the power generated by the solar power inverter; and
at the determined start time, beginning ramping down the power generated by the solar power inverter.

32. The method of claim 31 wherein the solar power inverter implements a maximum power point tracking algorithm that affects how much power is generated by the solar power inverter, and wherein the method further comprises:
at the determined start time, adjusting the maximum power point tracking algorithm to begin ramping down the power generated by the solar power inverter.

33. A computing system for predicting a decrease in solar power output of a photovoltaic plant having a photovoltaic array and sited at a location, the computing system comprising:
a processor; and
a memory containing:
cloud forecast data containing information about one or more clouds proximate to the location;
plane of array irradiance data containing information about a predictive plane of array irradiance at the photovoltaic array at a future time; and
a facility programmed to—
utilize the cloud forecast data to predict an effect of a cloud upon plane of array irradiance at the photovoltaic array at the future time; and
utilize the predicted effect upon the plane of array irradiance to predict a power transient of the photovoltaic plant at the future time.

34. The computing system of 33, further comprising a data input component configured to periodically receive cloud forecast data and plane of array irradiance data.

35. A solar power inverter comprising:
a direct current (DC) input component configured to receive DC produced by one or more photovoltaic modules;
a power generation component configured to generate alternating current (AC) from the DC;
an AC output component configured to output generated AC;
a data input component configured to receive signals indicating solar power forecast data; and
a controller configured to—
implement a maximum power point tracking algorithm for the one or more photovoltaic modules; and
adjust the maximum power point tracking algorithm based on the solar power forecast data.

36. The solar power inverter of claim 35 wherein the controller is further configured to adjust the maximum power point tracking algorithm by decreasing a frequency with which an operating voltage of the photovoltaic modules is changed.

37. A method of controlling power produced by one or more photovoltaic modules, the method comprising:
receiving a prediction of future power output by a photovoltaic plant, wherein the photovoltaic plant includes one or more photovoltaic modules that produce direct current (DC) and a solar power inverter that generates alternating current (AC) from the DC, and wherein the solar power inverter implements a maximum power point tracking algorithm for the one or more photovoltaic modules; and
based on the prediction of future power output, controlling the maximum power point tracking algorithm.

38. The method of claim 37 wherein controlling the maximum power point tracking algorithm includes modifying a frequency with which the solar power inverter adjusts an operating parameter for the one or more photovoltaic modules.

39. The method of claim 37 wherein controlling the maximum power point tracking algorithm includes modifying an operating parameter for the one or more photovoltaic modules.

40. A method of controlling an energy storage device, the method comprising:
accessing a prediction of future solar power output by a photovoltaic plant, wherein the photovoltaic plant includes—
a photovoltaic array that generates direct current (DC);
a solar power inverter that converts DC from the photovoltaic array to alternating current (AC) usable by a utility grid;
an energy storage device that stores energy; and
an controller that controls transfer of energy to and from the energy storage device;
controlling, by the controller, transfer of energy to or from the energy storage device based upon the prediction of future solar power output.

41. The method of claim 40 wherein the energy storage device includes a battery and wherein controlling transfer of energy to or from the energy storage device includes charging the battery at a rate based upon the prediction of future solar power output.

42. The method of claim 40, further comprising transferring energy from the energy storage device for provision to the utility grid based upon a predicted decrease in future solar power output.

43. The method of claim 42, further comprising providing energy to the utility grid according to a predetermined profile.

44. The method of claim 40, further comprising transferring energy to the energy storage device based upon a predicted increase in future solar power output.
